(19) United States
(12) Patent Application Publication
(10) Pub. No.: US 2022/0178487 A1
(43) Pub. Date: Jun. 9, 2022

(54) SPRINKLER REPAIR KIT

(71) Applicant: Anthony Davies, Sacramento, CA (US)

(72) Inventor: Anthony Davies, Sacramento, CA (US)

(21) Appl. No.: 17/111,301

(22) Filed: Dec. 3, 2020

(51) Int. Cl. F16L 55/18; F16K 51/00

(52) U.S. Cl. CPC F16L 55/18; F16K 51/00

(57) ABSTRACT

A kit comprising an adapter, having a slip end and a reverse-threaded end, and a pipe nipple having standard threads on one end and reversed threads on the other end. And the kit has PVC or other pipe cement, fittings with standard slip threaded connections blades, saws, cutters, or other irrigation pipe cutters, and valves, among other components.

A method for repairing a valve manifold with the steps of cutting a pipe system near a broken component (such as a valve); connecting a slip end of an adapter having a slip end and a reverse-threaded end to the system (sometimes gluing the connection with cement); removing the broken component from the system; attaching a replacement for the broken component; supplying a pipe nipple having a threaded end and a reverse-threaded end; inserting the pipe nipple into the normal threaded end and the reverse-threaded end; and tightening the pipe nipple to yield sealed joints.

### BACKGROUND

Without prior knowledge of sprinkler systems, it's hard to understand the steps of changing out sprinkler manifold systems. This repair typically requires a homeowner to contact a professional for assistance, which can be costly.

### TECHNICAL FIELD

The present invention generally relates to the field of irrigation equipment and, more specifically, relates to plumbing components for repairing irrigation systems.

### SUMMARY

Given these disadvantages inherent in the known art, this disclosure provides a novel repair kit.

A kit comprising an adapter, having a slip end and a reverse-threaded end, and a pipe nipple having standard threads on one end and reversed threads on the other end is disclosed. And the kit has PVC or other pipe cement, fittings with standard slip threaded connections blades, saws, cutters, or other irrigation pipe cutters, and valves, among other components.

A method for repairing a valve manifold with the steps of cutting a pipe system near a broken component (such as a valve); connecting a slip end of an adapter having a slip end and a reverse-threaded end to the system (sometimes gluing the connection with cement); removing the broken component from the system; attaching a replacement for the broken component; supplying a pipe nipple having a threaded end and a reverse-threaded end; inserting the pipe nipple into the normally threaded end and the reverse-threaded end; and tightening the pipe nipple to yield sealed joints is disclosed.

### BRIEF DESCRIPTION OF THE DRAWINGS

The figures that accompany the written portion of this specification illustrate variations and methods of use for the present devices.

FIG. 1A is a perspective view of a prior art valve manifold.

FIG. 1B is a perspective view of a prior art thread adapter.

FIG. 1C is a perspective view of a prior art valve manifold pipe assembly.

FIG. 2 is a perspective view of a repaired assembly.

FIG. 3 is a perspective view of a threaded coupler.

FIG. 4 is an exploded view of a repair couple.

FIG. 5 is a flowchart depicting a method of repairing a valve manifold.

### DETAILED DESCRIPTION

Unless defined otherwise, all technical and scientific terms used in this document have the same meanings as commonly understood by one skilled in the art to which the disclosed invention pertains. Singular forms—a, an, and the—include plural referents unless the context clearly indicates otherwise. Thus, for example, a reference to “fluid” refers to one or more fluids, such as two or more fluids, three or more fluids, etc. When an aspect is said to include a list of components, the list is representative. If the component choice is specifically limited to the list, the disclosure will say so.

Listing components acknowledges that exemplars exist for each component and any combination of the components—including combinations that specifically exclude any one or any combination of the listed components. For example, “component A is chosen from A, B, or C” discloses exemplars with A, B, C, AB, AC, BC, and ABC. It also discloses (AB but not C), (AC but not B), and (BC but not A) as exemplars, for example. Combinations that one of ordinary skill in the art knows to be incompatible with each other or with the components' function in the invention are excluded from the invention, in some exemplars.

When an element or layer is called being “on”, “engaged to”, “connected to” or “coupled to” another element or layer, it may be directly on, engaged, connected, or coupled to the other element or layer, or intervening elements or layers may be present. When an element is called being “directly on”, “directly engaged to”, “directly connected to”, or “directly coupled to” another element or layer, there may be no intervening elements or layers present. Other words used to describe the relationship between elements should be interpreted in a like fashion (e.g., “between” versus “directly between”, “adjacent” versus “directly adjacent”, etc.).

Although the terms first, second, third, etc., may describe various elements, components, regions, layers, or sections, these elements, components, regions, layers, or sections should not be limited by these terms. These terms may only distinguish one element, component, region, layer, or section from another region, layer, or section. Terms such as “first”, “second”, and other numerical terms do not imply a sequence or order unless indicated by the context. Thus, a first element, component, region, layer, or section discussed below could be termed a second element, component, region, layer, or section without departing from this disclosure.

Spatially relative terms, such as “inner”, “outer”, “beneath”, “below”, “lower”, “above”, “upper” and the like, may be used for ease of description to describe one element or feature's relationship to another element or feature as illustrated in the figures. Spatially relative terms may be intended to encompass different orientations of the device in use or operation besides the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors interpreted accordingly.

The description of the exemplars has been provided for illustration and description. It is not intended to be exhaustive or to limit the invention. Individual elements or features of a particular exemplar rarely are limited to that exemplar but, where applicable, are interchangeable and can be used in a selected exemplar, even if not explicitly shown or described. The same may also be varied. Such variations are not a departure from the invention, and all such modifications are included within the invention's scope.

A suitable solution is desired. Solution: The present invention provides a sprinkler manifold repair kit that enables homeowners to easily change the sprinkler manifold with limited knowledge of sprinkler systems. The device simplifies the process of changing out the manifold without having to contract professional assistance. It allows for easy installation and removal of the manifold. The device may comprise a male union piece and a female union piece. The present invention can be any material and of any diameter to match the existing material.

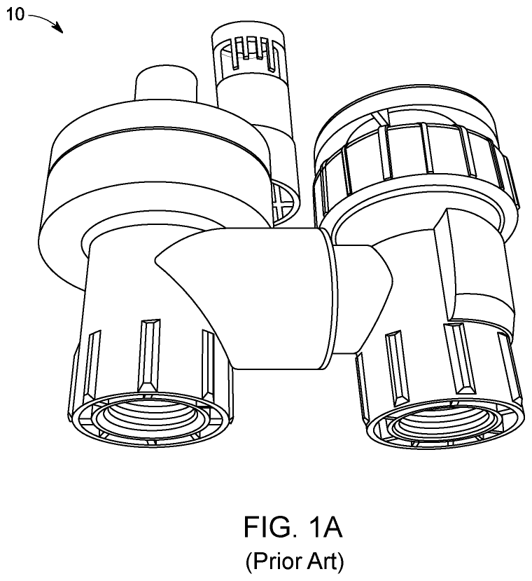

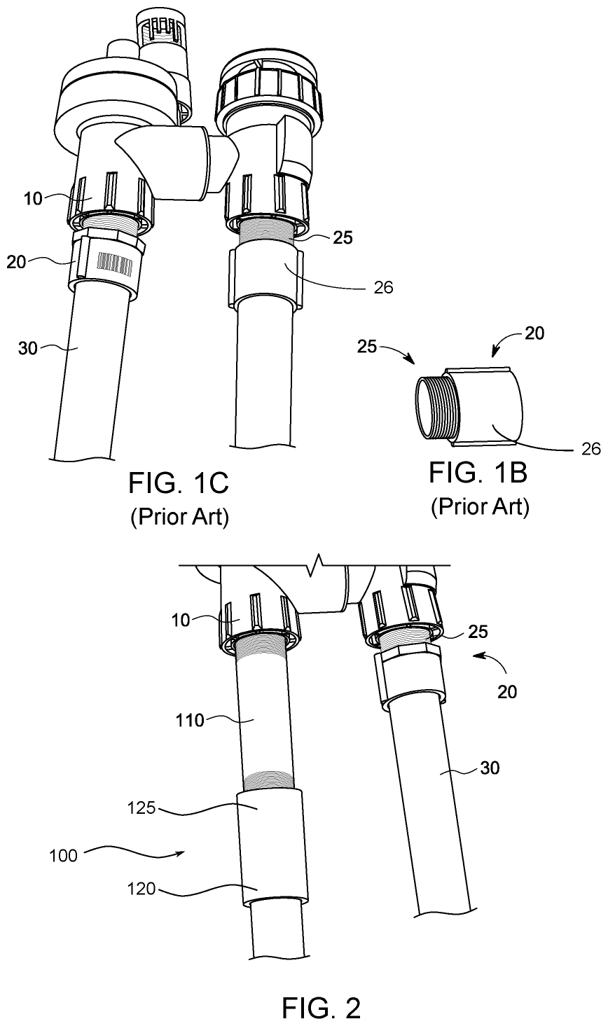

Frequently, valve manifolds such as these are used to control irrigation water in landscapes. The version depicted in FIG. 1A has been equipped for automatic operation. These manifolds 10 are virtually ubiquitous in residential irrigation. And they or components connected to them frequently fail. Repairing valve manifolds 10 is even more troublesome than installing here negation because the irrigation system is assembled using inexpensive but permanent methods.

Therefore, typical homeowners don't have the knowledge or skills to repair the systems themselves. And even more advanced homeowners don't have the knowledge or skills to make the repair aesthetic pleasing. Most systems are permanently assembled with PVC pipe, PVC fittings, and PVC glue. Repair requires reconstruction of the pipelines and the knowledge of preparing PVC glue joints, plus the user's ability to precisely fit repaired portions into the intact portion of the system.

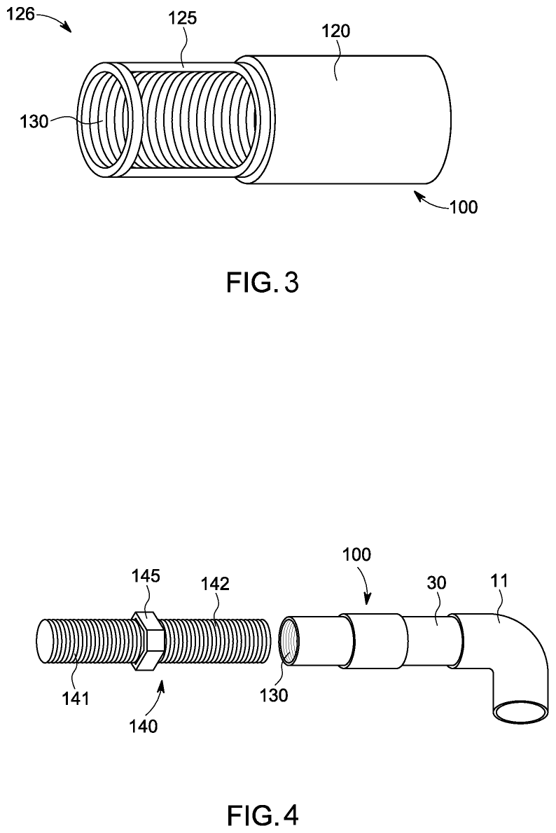

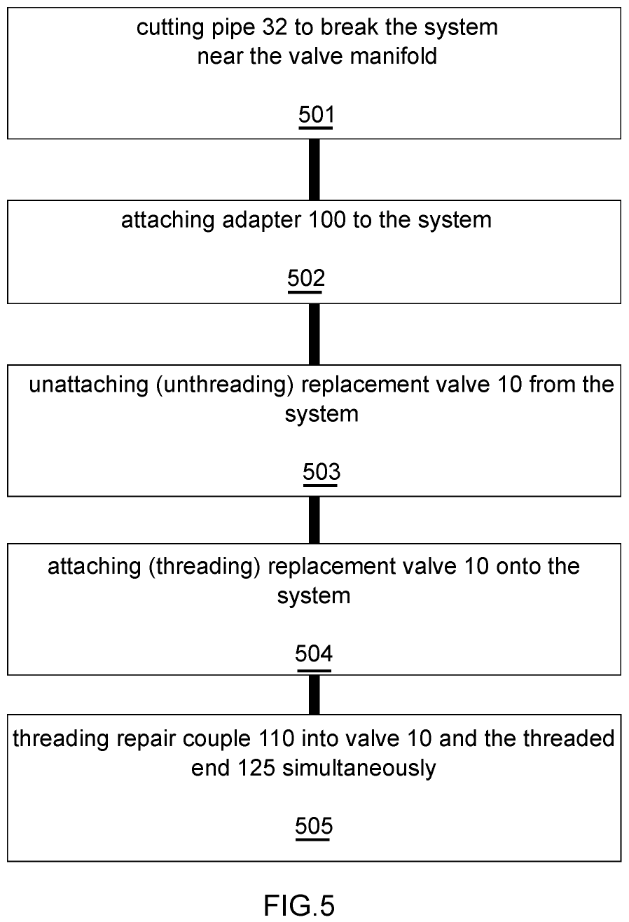

Some versions of valve manifold 10 have threaded input and output fittings. Frequently, these are connected to the irrigation system through thread adapter 20. As depicted in FIG. 1B, adapter 20 has threads 25 and slip region 26. FIG. 1C depicts valve manifold 10, thread adapter 20 (connected to the entry and the exit of the valve through threads 25 and matching threads in valve manifold 10), and pipe 30. This assembly is permanent. Since the other ends of the pipe are glued in place, this construction prevents pipe 30 and thread adapter 20 from being removed from valve manifold 10. The connection can't be unthreaded from the valve manifold 10. While the pipe can be easily cut, reassembly is beyond most homeowners' ability. FIG. 2 depicts a version of repair couple 110 as used to reattach pipe 30 to valve manifold 10. Repair couple 110 attaches valve manifold 10 (the threaded portion) to the thread couple 100. Thread couple 100 attaches to pipe 30 through the slip end 120 of thread couple 100. FIG. 3 shows thread coupler 100 with window 126 open into the interior of thread couple 100, with slip end 120, and threaded end 125. Window 126 shows that thread coupler 100 has interior coupler threads 130. In some embodiments, coupler threads 130 are reverse threaded or left-hand threaded.

FIG. 4 shows pipe 30 connecting between an elbow 11 and slip end 100 using a glue connection. Repair couple 110 has threaded end 141 and reversed threaded end 142. Reverse threaded end 142 matches and threads into interior coupler threads 130 in versions of thread coupler 100 having reverse threads. The version of the repair coupler depicted in FIG. 4 is threaded along the entire length, reverse threads on one end and normal threads on the other end. Grip 145 is shown as a hex grip. But exemplars exist in which grip 145 has various shapes or gripping mechanisms. For example, grip 145 is round with a grip surface, such as a rigid or rough surface, in some exemplars.

The repair method 500 of a valve manifold 10—pipe 30 system comprises the steps of step 501 cutting pipe 32 to break the system near the valve manifold. Step 502, attaching adapter 100 to the system. Step 503, attaching (unthreading) valve 10 from the system. Step 504, attaching (threading) replacement valve 10 onto the system (leaving a break between valve 10 and adapter 100). Step 505, threading simultaneously repair couple 110 into valve 10 and the threaded end 125. Since threaded end 125 is reversed threaded, repair couple 110 threads into and tightened into valve 10 and threaded at 125 the same time, re-unifying the system. The process is similar for any component threaded into the system at two points. Repair couple one is connected to an end of a break, and a standard slip thread adapter is connected to the other end of the break. Repair couple 110 can then join the threaded ends as before. But the repair couple 110 allows for less accuracy in the distance between break ends than using slip joints on the ends of the break. This makes it easier for homeowners without sharp skills to repair or replace the broken component.

While particular exemplars of the present invention have been shown and described, it will be obvious to those skilled in the art that changes and modifications can be made without departing from the exemplars of this invention in its broader aspects and, therefore, the appended claims are to encompass within their scope all such changes and modifications as fall within the true, intended, explained, disclose, and understood scope and spirit of this invention's multitudinous exemplars and alternative descriptions.

And various exemplars have been described above. For convenience's sake, combinations of aspects composing invention exemplars have been listed in such a way that one of ordinary skill in the art may read them exclusive of each other when they are not necessarily intended to be exclusive. But a recitation of an aspect for one exemplar discloses its use in all exemplars in which that aspect can be incorporated without undue experimentation. In like manner, a recitation of an aspect as composing part of an exemplar is a tacit recognition that a supplementary exemplar exists that specifically excludes that aspect. All patents, test procedures, and other documents cited in this specification are incorporated by reference if this material follows this specification and for all jurisdictions in which such incorporation is permitted.

What is claimed is:

1. A kit comprising an adapter, having a slip end and a reverse-threaded end, and a pipe nipple having standard threads on one end and reversed threads on the other end.

2. The kit of claim 1 further comprising PVC or other pipe cement.

3. The kit of claim 2 further comprising a standard slip threaded connection.

4. The kit of claim 3 further comprising a blade, saw, cutter, or other irrigation pipe cutter.

5. The kit of claim 4 further comprising a valve.

6. A method comprising cutting a pipe system near a broken component; connecting a slip end of an adapter having a slip end and a reverse-threaded end to the system.

7. The method of claim 6 further comprising removing the broken component from the system.

8. The method of claim 7 further comprising attaching a replacement for the broken component.

9. The method of claim 8 further comprising supplying a pipe nipple having a threaded end and a reverse-threaded end.

10. The method of claim 9 further comprising inserting the pipe nipple into the normally threaded end and the reverse-threaded end and tightening the pipe nipple to yield sealed joints.

11. The method of claim 10, wherein the connecting step comprises gluing the slip connection to the pipe with cement.

12. The method of claim 11, wherein the broken component is a valve.
